(19) United States
(12) Patent Application Publication
(10) Pub. No.: US 2006/0235777 A1
(43) Pub. Date: Oct. 19, 2006

(54) Method and system for specialized financial management

(76) Inventor: Melvin M. Takata, Thousand Oaks, CA (US)

Correspondence Address: MORRISON & FOERSTER LLP, 755 PAGE MILL RD, PALO ALTO, CA, 94304-1018, US

(21) Appl. No.: 11/107,377

(22) Filed: Apr. 14, 2005

(51) Int. Cl. G06Q 40/00

(52) U.S. Cl. 705/35

(57) ABSTRACT

System and method for augmenting standard financial services products (e.g., bank accounts) for specialized needs such as for children. This involves augmenting existing types of financial services accounts and adding new types of accounts not now offered by financial institutions such as banks. For instance in the present system, a parent can allow a child to access his actual bank account via the parent's actual bank account to support transactions between the parent and child such as paying an allowance, cash withdrawals and deposits, and paying additional interest on the child's account.

### FIELD OF INVENTION

The present invention relates to financial services and in particular to augmenting and modifying financial services products for specialized needs (such as for children).

### BACKGROUND

Generally, banks and savings institutions and credit unions and other financial institutions such as stock brokerages have a difficult time servicing the needs of children (and other low wealth individuals) and generating a profit at the same time. There are a number of reasons for this: Children generate the same number of transactions or more than adults, but at much smaller transaction amounts. In order to transact (make deposits and withdrawals) parents (guardians, relatives, etc.) need to take children to the bank branch or the bank needs to offer more convenient and specialized transaction locations (such as at schools).

The products offered by financial institutions must generate profit as well as meet adult market needs. As such, offering products that would incent children (higher interest rates, matching funds, smaller lot transactions at reasonable cost) is difficult or impossible. Balances on children's accounts are on average much lower than for adults. For example, if a child received an allowance of $5.00 a week and deposits $5.00 into a bank every week in person, the bank transaction costs would be extremely high. In addition, this would not be convenient for the child or the parents. With such a bank account, withdrawing less than $10.00 cannot typically be done at an ATM (automated teller machine) and is inconvenient in person.

There are specialized “financial products” individual to each family that parents directly offer their children and that children need in order to learn the basics of money management on their terms. For example, a child may want a new bike, which costs $60.00. The parents may offer to the child, “If you save $40.00 over the next three months, then we will kick in the rest and you can get the bike.” No financial institution will offer such a savings plan. In addition, children would like to be able to monitor their progress towards that goal. Alternately, the parents can, for example, offer the following—“We will give you 50% interest on your money over three months if you save it, and then you will have the money to buy a new bike”. Banks are not in a position to do this either.

An issue addressed here is that financial institutions are motivated by profit; parents acting as financial entities are motivated to teach their children key financial principles.

Also, opening a new account with a financial institution is a time consuming process requiring signatures and a face-to-face interaction between the customer and a representative of the financial institution. This is the case even when an existing customer of the financial institution wishes to open a new account with the same financial institution. Often times, customers want to open new accounts, such as a savings account, simply to help manage their finances by compartmentalizing their funds. Such is the case when saving for different purposes (such as a new car versus holiday gifts). This is not easily done under the present banking system.

Additionally, financial institutions are subject to certain regulations imposed by governmental entities (such as the Federal Reserve Board). For example, Regulation D defines reserve requirements for deposit account (such as checking and savings), and can place limits on the frequency of withdrawals on specific types of accounts. Children may prefer to do smaller but more frequent transactions than the general public, and meeting these needs can be difficult for financial institutions.

### SUMMARY

This disclosure is directed to a computer-based system having an information processing system (IPS) that allows an authorized third party to augment the conventional financial products (accounts, etc.) offered by financial institutions and deliver such augmented products to a set of customers. Disclosed here are processes that allow this to happen between three entities: financial institutions, customers and third parties. Third parties are, e.g., parents or guardians or relatives or a commercial business. Parent is used instead of third party in some illustrations below for readability. The financial institution is the holder of the actual funds e.g., a bank or brokerage. The customer is the end user typically whose funds the financial institution is holding. Child is used instead of customer in some illustrations below for readability. The associated system includes in some embodiment an information processing system (IPS), which can be either separate and distinct from those of the financial institution whose financial services products are being augmented, or integrated or incorporated as part of that financial institution's existing systems. There are no new functional requirements imposed on the conventional information processing systems of the financial institutions. Computer-based systems in accordance with this invention use a well defined set of functions commonly available in the information processing systems of financial institutions. These include retrieving the balances of accounts and the transaction history for accounts, and transferring funds between accounts at the same financial institutions. A process is provided that permits financial institutions to authorize third parties to augment products (e.g. accounts) for specified customers in ways described below. There is the ability for the customers of these augmented accounts to manage their accounts on-line. The terms of these accounts are defined by the authorized third party.

Enhanced features that can be provided include withdrawals through the third party account, so that, for example, children can withdraw money from their actual account by getting cash directly from their parents. This manifests itself on-line as a new transaction that results in money being transferred from the child's actual account to the parent's actual account. Deposits may be made through a third party, so that, for example, children can deposit money in their actual account, by giving cash or checks directly to their parents. This manifests itself on-line as a new transaction that results in money being transferred from the parent's actual account to the child's actual account. Recurring transfers from third party account (parent) to customer account (child), can be set up by the third party. A common use of this is for the child's allowance. There is also the ability for a third party to augment the interest paid by the financial institution so that the customer sees an effective interest rate that is higher than what the financial institution offers. A typical use is for parents to provide augmented accounts to children with higher interest rates that offered by the financial institution. This is implemented by periodically computing the higher interest, transferring money from the parent's actual account to the child's actual account with a memo, amount, transfer frequency and date determined by the parent.

There is the ability for third parties to set up specific rewards and/or penalties as part of the augmented account, so that the child experiences an augmented account with different characteristics than his underlying (actual) account as offered by the financial institution. Such rewards and/or penalties can be triggered by predefined events or combinations of events, including but not limited to a deposit of a specific amount, a withdrawal of a specific amount, a balance of a specific amount before a specific date, a withdrawal before or after a specific date. Rewards are implemented by transferring money from the third party's actual account to the customer's actual account, and penalties are implemented by transferring money from the customer's actual account to the third party's actual account. Such capabilities allow third parties to include augmented features such as matching funds or penalties for early withdrawal. There is the ability for parents to set up loans and lines of credit for their children, and for children to set up loans to their parents. These loans typically do not have an underlying account or embodiment at the financial institution. That is, there is no actual loan from the financial institution to either the parent or the child. A parent's loan to a child is implemented, e.g., in the following way: Approval is done by the parent. The present system may provide some assistance, such as standard forms and loan terms that can be included. The loan account is set up by the parent on the present system, by defining its terms (loan amount, repayment period, interest rate, etc.). Loan funding is triggered by the parent. The present system implements this by transferring money from the parent's actual account to the child's actual account. If there is collateral (such as a child's actual time deposit account), restrictions can be placed on the collateralized actual account by the parent. This is implemented in the present system by restricting the kinds and amounts of transactions permitted on the child's actual account for the specified time. The child then can make loan payments, either manually each time period or by setting up an automatic payment, on the present system. The present system implements a payment by transferring funds from the child's actual account to the parent's actual account.

Third party can also offer accounts where reward/penalties mirror those of some real financial investments, such as equities, mutual funds, bond, futures, options, gold, or real estate. The present system tracks the performance of such investments and posts investment status for the customer's account. Again the third party pledges to settle the investment gains and losses with the customer. For example, a child can purchase 2 shares of Disney stock through their virtual investment account setup by their parent. Child will not actually have purchased the stock, but will realize the gains, losses, and dividends of the purchase, as fulfilled by the parent. Third parties can define terms and fees on the accounts. And they can allow purchase/sale of things like fractional shares.

The present system also permits the integration of simple budgeting categories with actual spending. In such a system, the customer can budget spending across different categories over different periods of time (such as monthly). They can then set up virtual accounts for major categories of spending (e.g., clothes, gifts, fun). They can allocate income (allowance for kids) to different accounts, by setting up recurring transfers to their different virtual accounts. They can then get money from their respective virtual accounts for spending on particular items. The system presents a record of the budget vs spending.

This invention also applies when the real accounts of the customer and the third party are at different financial institutions. Technology and businesses exist to provide such capability. There may be some cost or business implications that make it less feasible at the current time. However, the invention is not limited to work with customer and third party accounts at a single financial institution.

Also provided is the ability for customers to open and manage new “virtual” accounts without needing to open a new actual account at the financial institution. These virtual accounts are implemented entirely on the present system IPS, with no changes needed to the financial institution IPS. The features of the virtual account (interest rate, matching feature, etc.) can be determined and funded by the third party (parent), and this function can be enabled by the third party (parent) who is administering these virtual accounts. There is in the context of such virtual accounts the ability for customers to continue to perform transaction through the normal distribution channels of the financial institution (ATM, teller, mail) and have the transactions reflected in a consistent, predetermined manner against the virtual accounts. This allows for a multiplicity of third parties who can participate in offering virtual accounts to customers. While parents may be the third party, other businesses or individuals can simultaneously provide customers (children) with various types of accounts.

### BRIEF DESCRIPTION OF THE FIGURES

FIGS. 1-18 show a set of “screen shots” as experienced by users of the present system;

FIG. 19 shows how the third party, customer and financial institution interact with the present system;

FIG. 20 shows an embodiment of the present system.

### DETAILED DESCRIPTION

Embodiments of the present system are implemented via computer software. The software can be executing either on a server, accessible by clients (customers/third parties) via the Internet, or running as an application program on a personal computing device at the customers/third parties, such as a personal computer (PC). It is this software that allows a third party to provide augmented and virtual financial products to customers, with the actual funds being held by a financial institution.

Coding such software in any convenient computer language would be routine for one of ordinary skill in the art in light of this disclosure. The present method and system are intended to operate in a typical personal computer/Internet environment which includes not only desktop computer systems but also laptop computers, palm-sized personal computers, personal digital assistants (PDA), mobile telephones, smart telephones, or by access through an Internet service provider (ISP). The data can thus be synchronized to a secure central data storage site for instance an IPS accessible through the Internet where the data can be accessed, previous transactions viewed, and where transactions can be made or allocated by any wired or wireless device with multiple, simultaneous connections to the same centralized data. Hence this also allows the system to interact with financial institutions, including banks, stock brokerages, etc.

The architecture of such a system is conventional and includes typically a secure Internet infrastructure including a provider gateway or server typically used for managing Internet type actions and Internet access and communication. These systems are well known in the computer networking field. The gateway provides two way communication between a user (customer/third party) and the financial institution as needed. The users connect to the gateway typically via a wireless connection or a wired connection or a cable modem or other cable type connection. Data security is provided as is well known in the financial services field. Typically, as far as the users go, the system operates in a graphical interface mode so users can manipulate data information using typically computer input devices such as a mouse and keyboard entry. The system typically at the user side operates within a Windows type or Macintosh computer operating system environment (but is not so limited).

Augmented Accounts

In order to implement customized (augmented) accounts for particular customers, the present system performs special transactions between two financial institution actual accounts: 1) the customer's actual account (e.g. child's account), and 2) the third party's actual account (e.g. parent's account). For example, if the parent wants to offer the child 10% interest on a savings account, then the interest payments are implemented as a transfer of money from the parent's actual account to the child's actual account, with a description of the transaction of “interest posted”. The transfer of funds takes place in the financial institution's IPS, but the description of “interest posted” can be kept by the present system. Without this tailoring of the transaction description to be other than the actual underlying finds transfer, the transaction would not make sense to the child. The accounts can be bank accounts (checking, savings, etc.) or brokerage accounts, but are not so limited. The present system preserves standard business processes for mitigating risk. For example, the present system allows a child or parent to execute transactions that result in pushing money out of their accounts, but not pulling money from someone else's. In the following, the child's deposit operation will illustrate how this is done.

In order to accomplish this, the present system effectively creates from the customer's aspect a “virtual bank” offering financial products (e.g. accounts or loans) having characteristics not available with actual financial institution accounts, such as augmented interest rates on savings or loans, or a matching funds provision. This virtual bank uses a method for matching transactions between the present system IPS and the IPS of the financial institution, and a method for combining the information about this transaction kept in the different IPS; in a way that achieves the desired effect of providing account customization by third parties for their customers. This is achieved, for instance, in one of the following several ways: (1) A unique transaction identifier, assigned by the financial institution IPS and made available to the present system IPS, is captured and stored in the present system IPS along with special information about the transaction. This unique identifier is typically a transaction ID number. (2) A unique transaction identifier is assigned by the,present system, and is sent to and stored in the financial institution IPS as part of a description or memorandum field by the transaction. This identifier is also stored by the present system IPS as part of the transaction. (3) A combination of data elements made available from the financial institution IPS, (such as date, amount, transaction type) is used to identify the transaction. This information is captured and stored by the present system's IPS. This combined information is used to uniquely identify the transaction in the financial institution IPS.

The present system allows the customer to effect transactions through conventional financial institution provided channels (such as via tellers, mail, or ATM). The present system thereby performs information management with two distinct faces: one for the customer (e.g. child) and one for the third party (e.g. parent). Both faces take the form, in some embodiments, of a software program on a server accessible through the Internet to a customer/third party client program or browser, or a client application program running on a PC.

The face to the child is the virtual bank that allows the child to see, track, and transact with his actual (e.g., bank) account such as a checking or savings account. This actual bank account is held by the financial institution. The present system implements transactions and augments information from the financial institution to implement the desired virtual financial services product as defined by the third party.

The other face is to the parents (third parties) who are given the ability to define augmented account characteristics tailored for their children (customers). Parents are also given tools to administer, service, and monitor their children's accounts. To the child, his customized (augmented) account typically appears as having at least as many restrictions as the financial institution has put on his actual account, such as no overdraft privileges, minimum balance, etc. although the parent can modify these restrictions if he wants.

Virtual Accounts

The present system in some embodiments allows customers to open and manage “virtual” accounts based on their existing actual account at the financial institution (also called here the underlying account). These virtual accounts may have features and characteristics defined by a third party (not the financial institution), as described above. These virtual accounts are managed by the present system IPS, without necessarily any modifications to the financial institution conventional IPS.

The present system creates a primary virtual account and attaches it to (associates with) the underlying account. It then allows the customer to create any number of new virtual accounts also attached to the underlying account. These virtual accounts exist only within the present system IPS, and not on the financial institution IPS. The present system manages these virtual accounts, such that the total balance for all virtual accounts attached to a specific underlying account equals the balance in the underlying account.

The present system accomplishes this by reconciling all transactions against the underlying account and against each of the attached virtual accounts.. Since the financial institution typically has no information at all about the virtual accounts, all transactions involving these virtual accounts are executed via the present system. Transactions performed through the financial institution are executed only against the underlying account and the present system IPS reflects them in the primary virtual account.

The present system uses at least three types of transactions: Type 1—External; 2—Hybrid; and Type 3—Internal. Table 1 lists these three transaction types and how the financial institution's IPS and the present system handle each.

TABLE 1
Summary of Transaction Types

| Type of Transaction | | System Function | |
|---|---|---|---|
| Transaction | | Financial Institution | |
| Type | Name | Information Processing | Present System |
| Type 1 | External | Captures Normal Txn | Nothing |
| Type 2 | Hybrid | Captures Normal Txn | Captures augmented |
| | | | information |
| Type 3 | Internal | None | Captures full |
| | | | information |

The External transaction (Type 1) is the conventional transaction performed through existing channels (ATM, teller, mail) against the underlying account. These transactions are implemented entirely on the financial institution IPS and the present system does not have a record of them until it queries the FI IPS. Examples of these transactions include deposits and withdrawals at a teller or ATM, or transfers performed at the ATM. In the present system, these transactions are placed into in the primary virtual account.

The Hybrid transactions (Type 2) are originated via the present system IPS and are executed on the financial institution IPS. The present system keeps track of additional information on the transaction and is able to match its record of a transaction with the record of the same transaction on the financial institution IPS using the matching technique described below. Examples of Hybrid transactions include deposit of a child's allowance (a transfer from parent's account to child's primary virtual account), and posting of “additional” interest (also a transfer from the third party's account to the appropriate child's virtual account).

The Internal transactions (Type 3) are performed entirely on the present system IPS. Examples of stand-alone transactions are the setting up of a new virtual account and a transfer of funds between two virtual accounts.

The present system can obtain information on External only transactions in any number of ways, including but not limited to 1) downloading a transaction history from the financial institution IPS as part of an on-line session with the customer, and 2) through a notification mechanism such as email or wireless message. At that time, the present system will update its balance for the primary virtual account.

All transactions that are not performed through the present system are posted by the present system to the primary virtual account. Therefore such transactions as a deposit by mail or teller, or withdrawal from an ATM are posted by the financial institution IPS to the underlying account and by the present system against the primary virtual account.

There are other aspects of how multiple virtual accounts are reconciled with activity in the underlying account. In particular, it is important to preserve and observe the rules that govern the availability of funds (Available Balance) vs. the amount credited to the account for purposes of computing interest (Current Balance). Reconciling balances and transactions between the underlying account and the collection of virtual accounts has the following issues. Some rules of the underlying account may cause balances to behave unexpectedly. For example, the minimum balance in an account is sometimes excluded from the Available Balance of the account. As another example, when a large check is deposited, financial institutions may impose a “Hold” on some or all of the funds, reducing the Available Balance. All Hybrid and Internal Type transactions are executed immediately, and do not impose a “Hold” or difference in the Current Balance and the Available Balance. Therefore, only External transactions will cause possible “Holds”. Since all External transactions are reflected in the primary virtual account, this allows the present system to have primary virtual account reflect any FI imposed difference between the Available and Current Balance, without requiring knowledge about the cause of such a difference.

A balance reconciliation process is also defined which (1) identifies any transactions on the FI's IPS that are new External transactions for the present system. The balances on the present system are updated appropriately; (2) identifies any transaction on the FI's IPS that corresponds to a new Hybrid transaction on the present system. The transaction of the present system is marked as reconciled so as not to be counted again. After all transactions are accounted for, account balances are compared and reconciled.

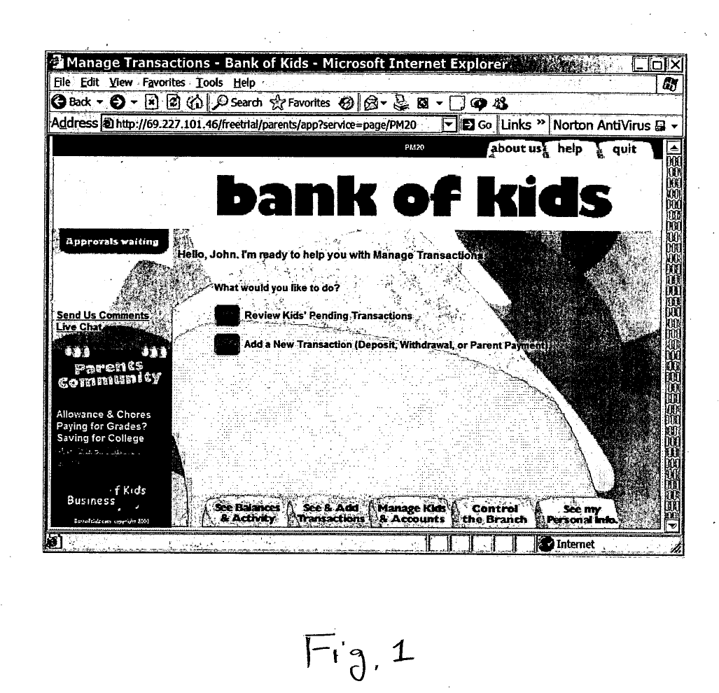

FIGS. 1-18 here show a set of “screen shots”, that is computer display screens, viewed by a user of a system typically a parent or child (kid) as he uses the present system. These are typically displayed here as Internet type web pages as viewed through a web browser such as the Microsoft Internet Explorer. Note that the particular array of elements in each screen shot is easily altered. The screens include typically tabs, control buttons, places to enter information, pop up boxes, etc. as is conventional of such interactive web pages.

FIG. 1 shows a screen whereby a parent may begin a process of approving a kid's transaction. The system in this case is called Bank of Kids which is a trade name. The web page of FIG. 1 is accessed through the conventional web browser Microsoft Internet Explorer with the conventional toolbars at the top. Using this screen, the parent can select “Approvals Waiting” in the upper left corner, or navigate to “See & Add Transactions” and then select “Review Kid's Pending Transactions”. The selection of elements on the screen is of course conventional using for instance a mouse or other tracking device. Note the possibility of conducting other types of transaction indicated by the tabs across the bottom of a screen.

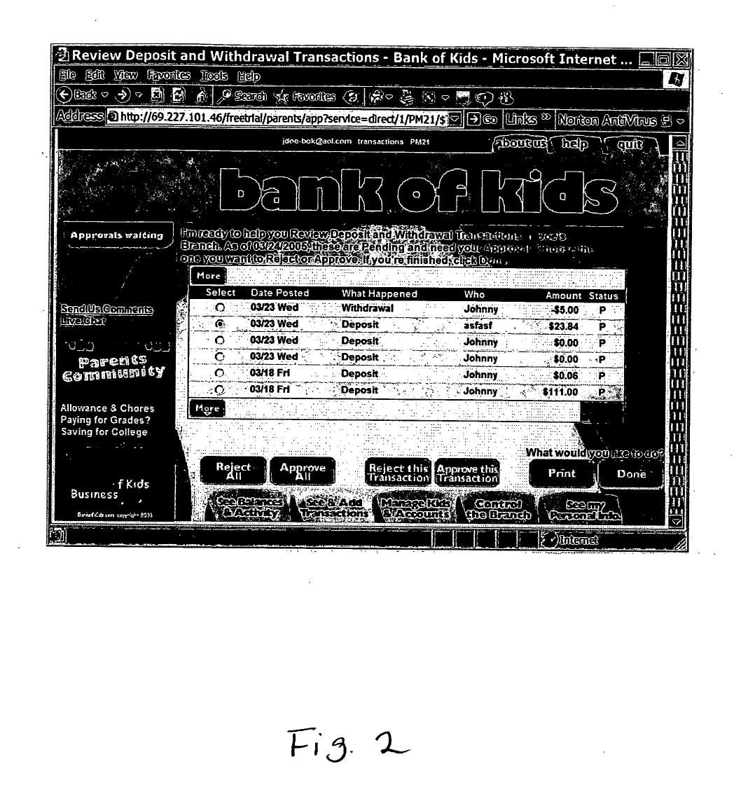

Next in FIG. 2 the parent then sees all the transactions that all of his children have entered that are still in the pending state. These are only withdrawal and deposit transactions in this case. The parent can then select a particular transaction that the parent wants to approve or reject and then click on the appropriate action using the select buttons and the Reject All or Approve All buttons.

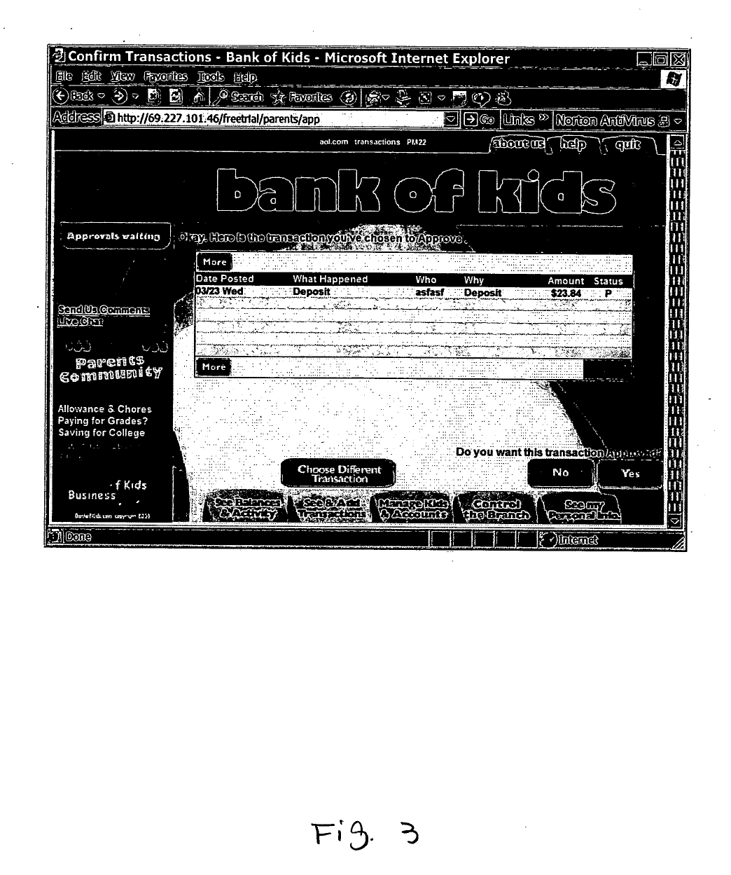

Next, in FIG. 3, the selected transaction is a deposit. This screen confirms that the deposit transaction will be approved. Actual approval then takes place in the lower right corner using the “Yes” or “No” buttons.

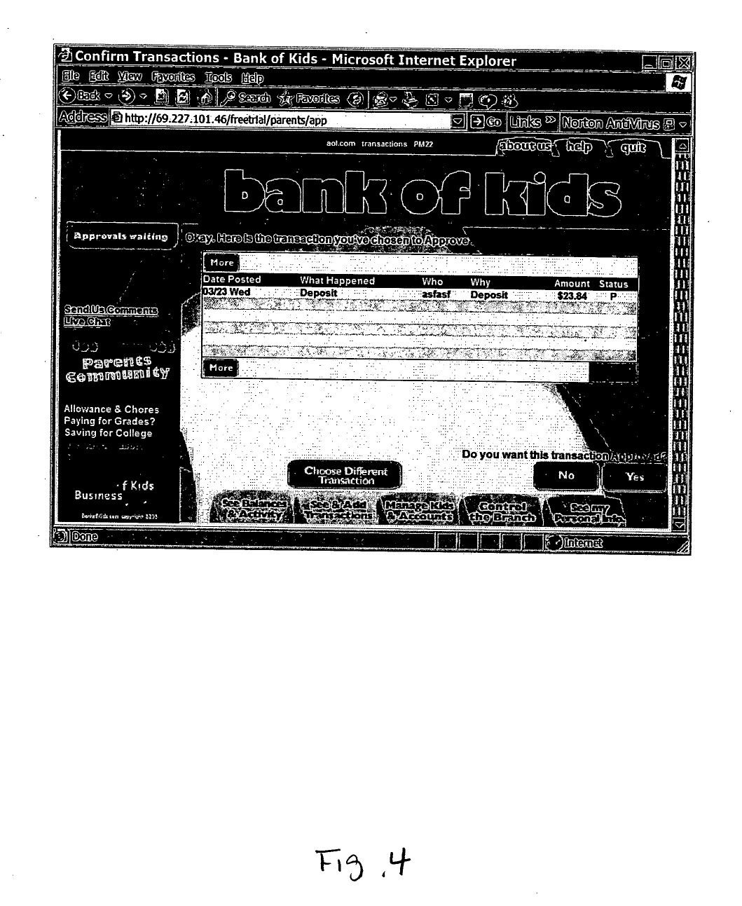

Next, in FIG. 4 in this case the selected transaction is a withdrawal. This screen confirms that the transaction will be approved similar to FIG. 3. Next, if the deposit is approved the parent will get a message along the lines of “I have marked the [Kid name]'s deposit as approved and moved the money from your account to [Kid name]'s.

Then typically a prompt is given asking if the parent would like to go ahead and see any other transaction, with a “Yes” “No” selection.

A similar message is provided in response to the withdrawal approval of FIG. 4.

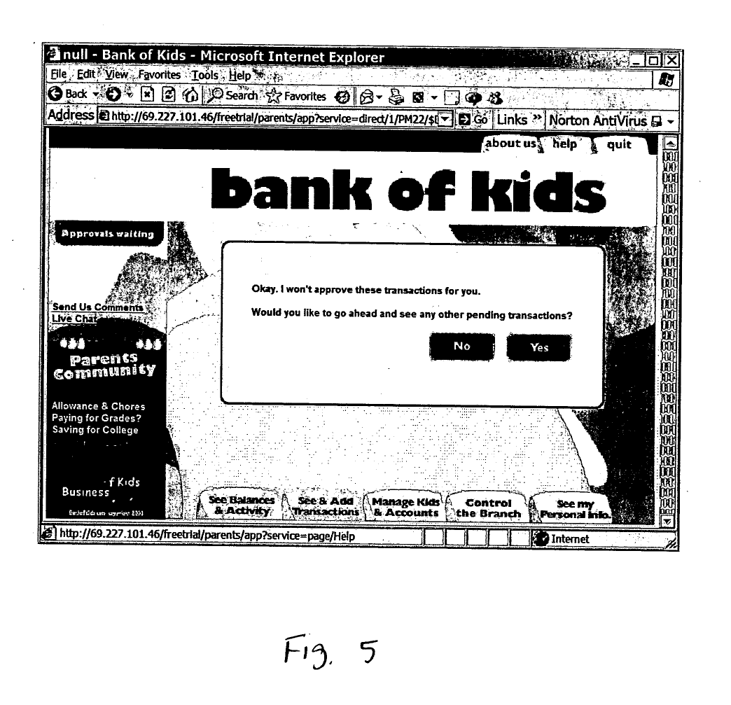

Next, FIG. 5 shows what happens if the parent refuses an approval of deposit or withdrawal, showing the message box in the center of the screen.

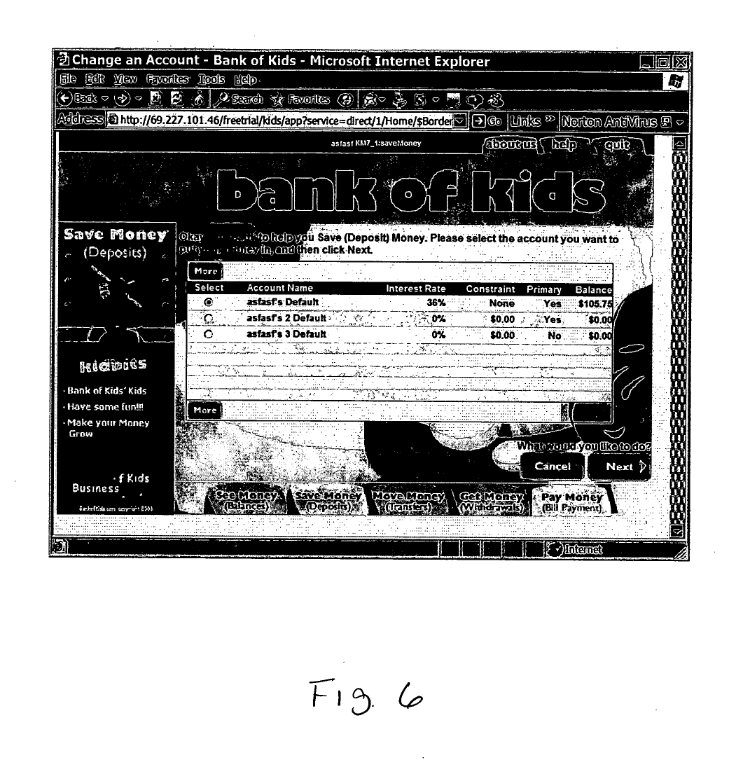

Beginning a new type of transaction, FIG. 6 shows a child making a deposit. This screen has been called up by the child. All of the child's account are listed with a summary of each account. These may be virtual accounts as explained above. The child selects the account that he wants to deposit the money into and then clicks “Next” in the lower right hand corner.

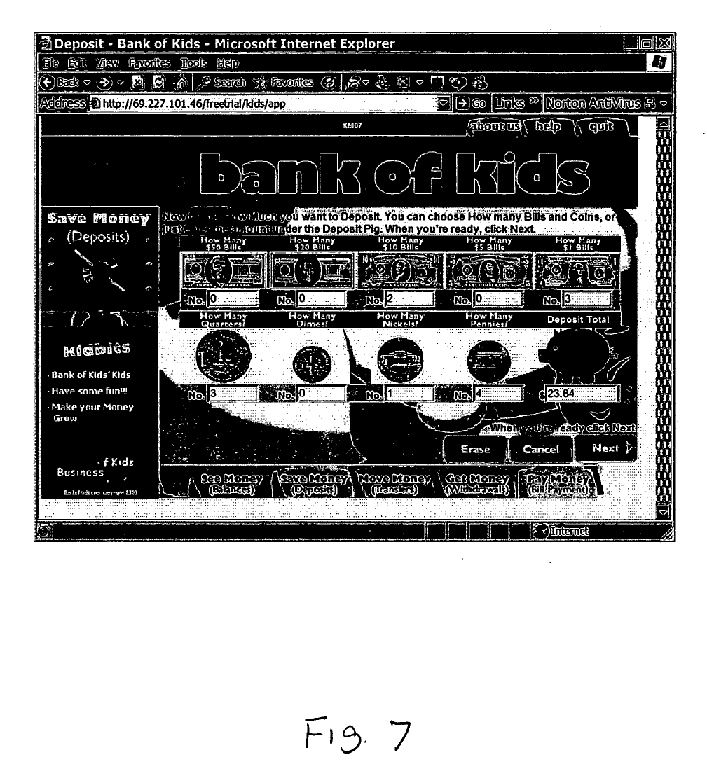

Next, in FIG. 7 the child enters, using his computer keyboard, the amount of money he wants to deposit, in this case, using the display of particular types of currency and coins. As an alternative the total amount is merely entered under the Pig icon. When the desired deposit amount has been met by either method, the child clicks “Next” in the lower right hand corner.

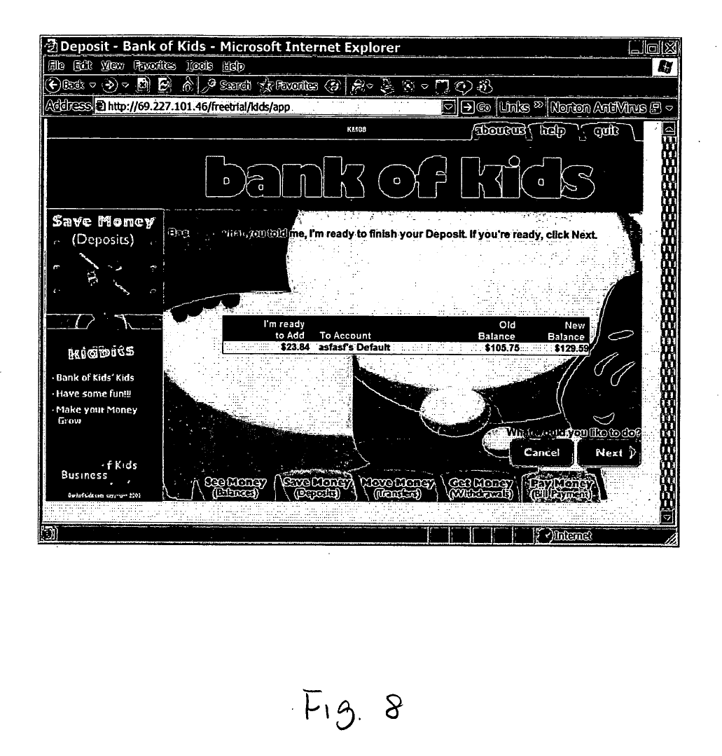

The next screen as shown in FIG. 8 shows the entered information in order to verify it. If it is correct, the child clicks “Next” in the lower right hand corner. At this point, the system creates the deposit transaction. However, no balances are updated and in the real account system (see below) no money is actually transferred at this point.

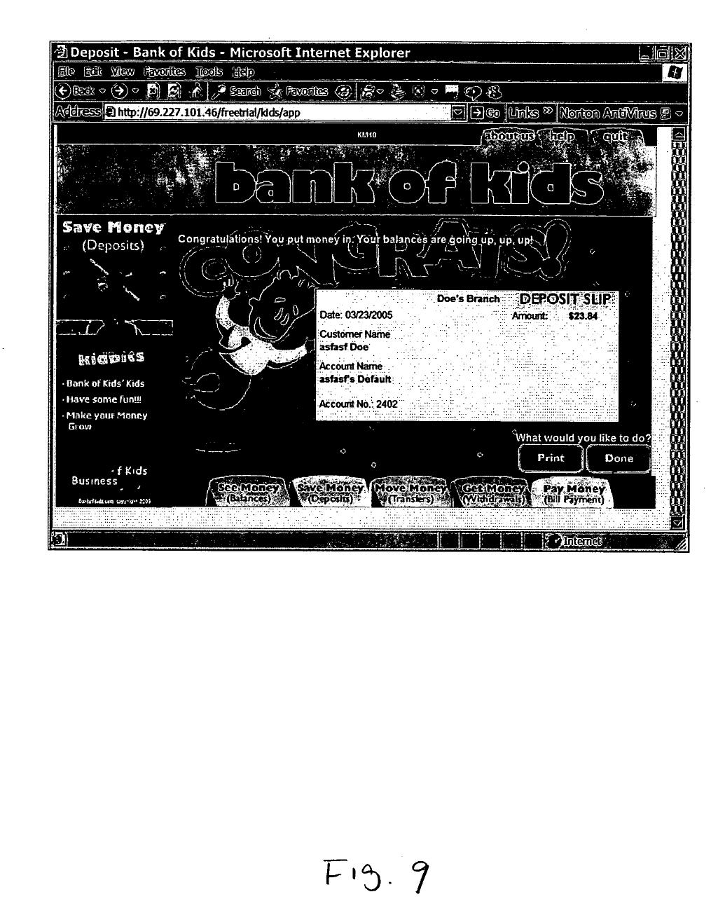

Next in FIG. 9, the child has the option to print out for his use the deposit slip so he can hand the deposit slip and the associated money to the parent. The printing is typically done using a computer printer attached to the computer used by the child.

In certain embodiments, there is also provided to the child on the screen a message along the lines “This deposit will appear in your account only after you give the deposit to your parents and your parent approves this deposit on [account no. ______] with Bank of Kids.

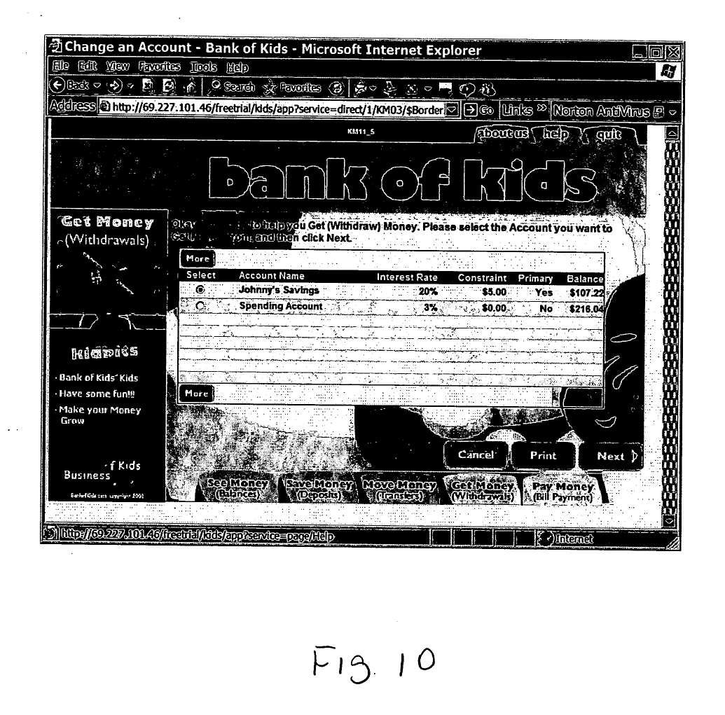

Next, shown in FIG. 10 is the first screen when the child wants to make a withdrawal from his account. In this case, the child selects the particular account from which he wants to withdraw the money. If there is a constraint on the account (typically imposed by the parent) the system will not let the child withdraw beyond that constraint at any one time.

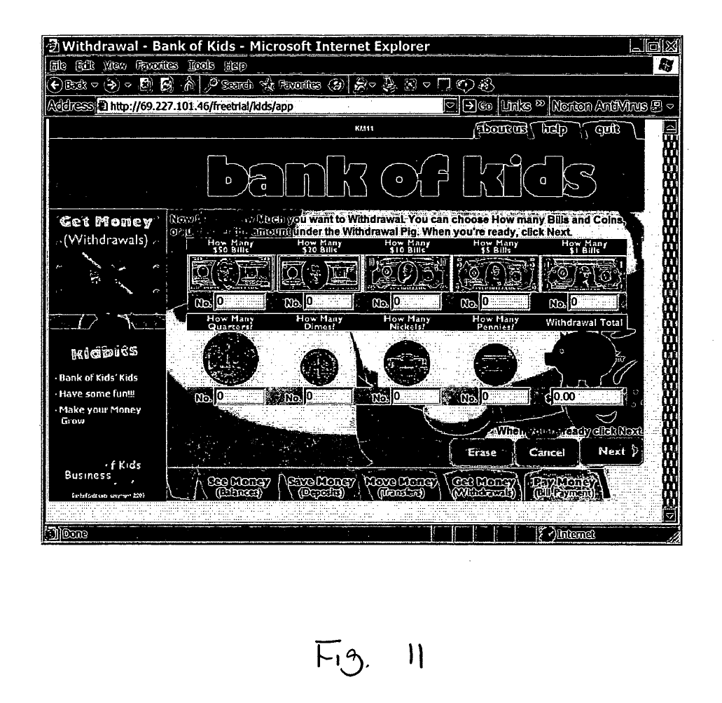

Next, in FIG. 11 the child enters the amount he wants to withdraw, similar as in the deposit amount screen referred to above FIG. 7.

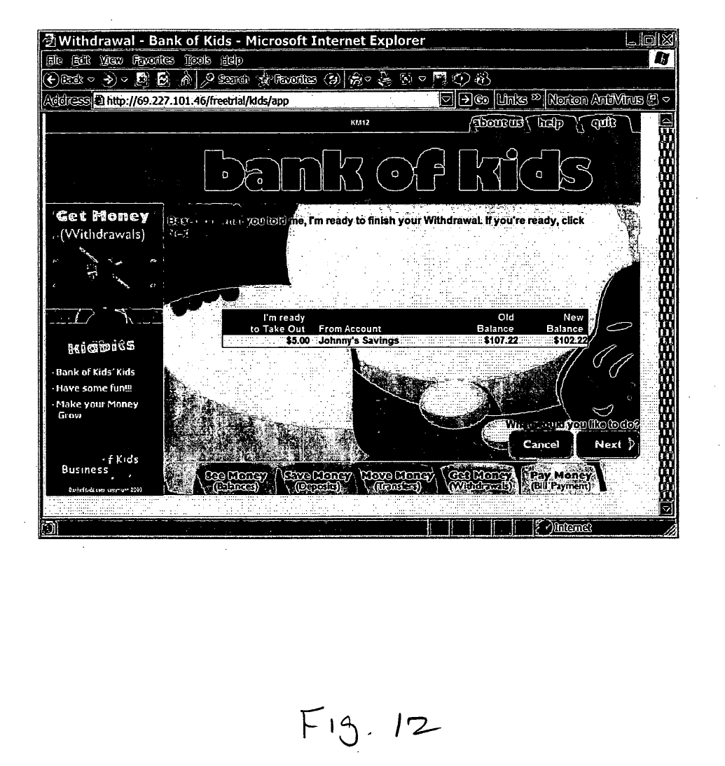

Next, in FIG. 12 after the child clicks “Next” in the lower right hand portion of FIG. 11, the system confirms by the FIG. 12 screen the information the child has provided. When the child clicks “Next” in FIG. 12, the system executes the withdrawal transaction. This includes issuing a request to the financial institution system to transfer the withdrawal amount from the child's financial institution account to the parent's financial institution account. If successful, the withdrawal transaction record is created on the system and placed in the “pending” state. This transaction will stay in that pending state until the parent changes its estate by approving as shown above.

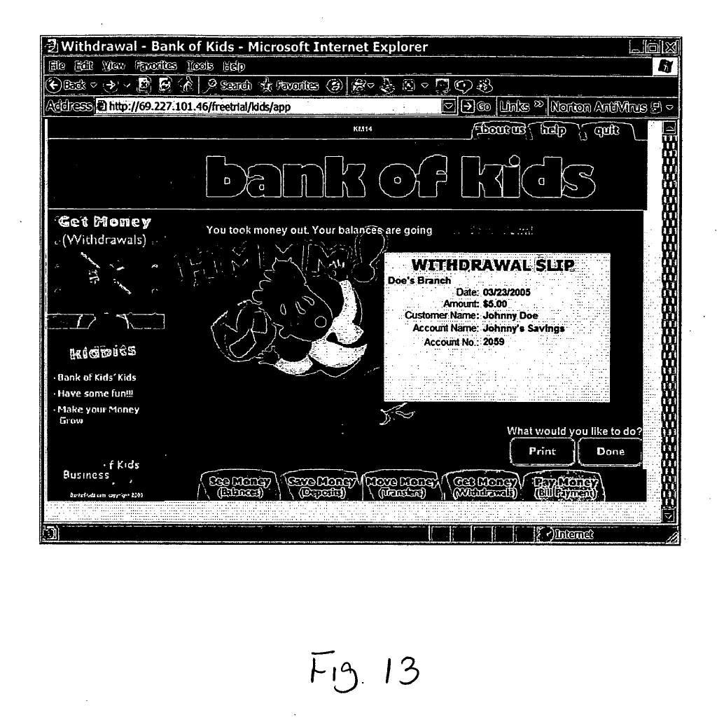

Next, the system displays a withdrawal slip as shown in FIG. 13 and allows the child if he wants to print out the withdrawal slip. The child can then take the withdrawal slip to his parent to obtain the cash from the parent.

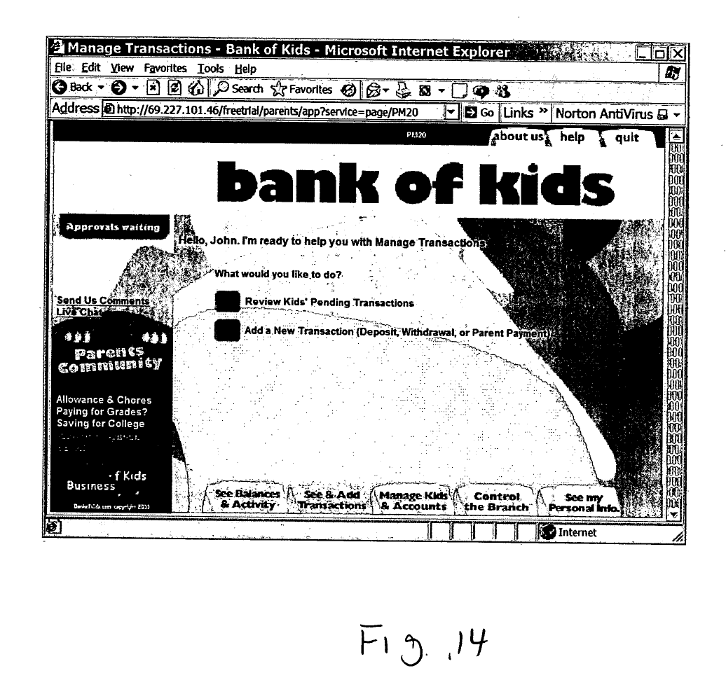

FIG. 14 shows the screen that occurs if the parent has rejected a child's transaction, that is refuses to approve it. In this case, the parent can select “Approvals waiting” in the upper left hand corner of this screen or navigate to the “See & Add transactions” in the lower part of the screen and the selects “Review Kid's Pending Transactions”.

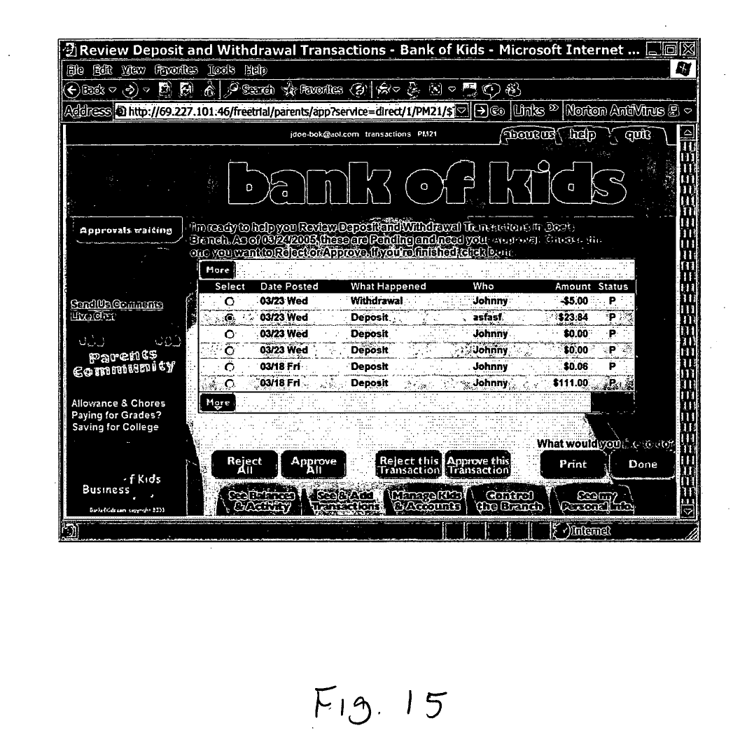

Next, in FIG. 15 the parent then sees this screen showing all the transactions that all of his children have entered that are still in the pending state. These may only be withdrawal and deposit transactions, as above. The parent can then selects any (or all) transactions he wants to approve or reject and then clicks the appropriate action.

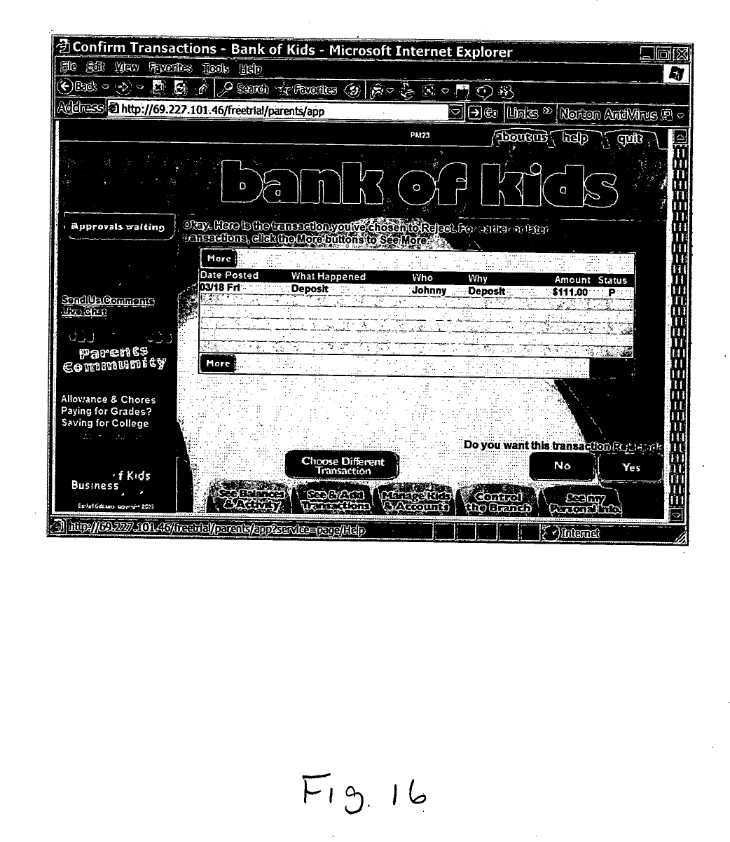

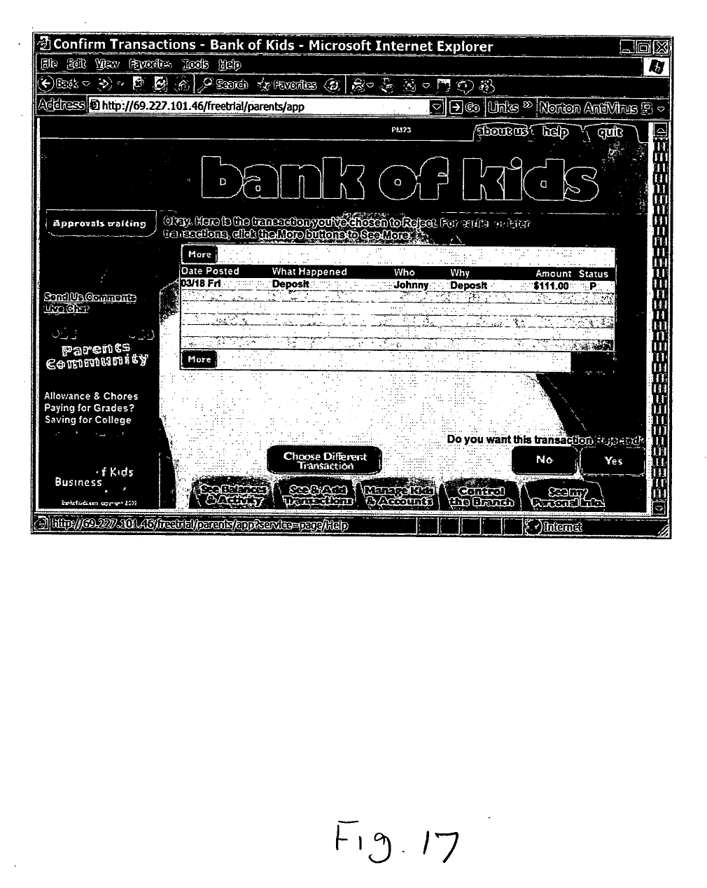

Next, in FIG. 16 the selected transaction is a deposit. This screen allows the parent to reject the transaction by clicking the “Yes” or “No” boxes in the lower right hand portion of the screen. Next, in FIG. 17 in case the particular transaction selected is a withdrawal this screen also allows confirmation if the transaction will be rejected or not, similar to FIG. 16. This allows the parent to cancel a transfer between the actual accounts of the parent and child by rejecting the withdrawal. If a deposit rejection occurs a suitable message is provided to the parent. A similar message is provided for a withdrawal rejection.

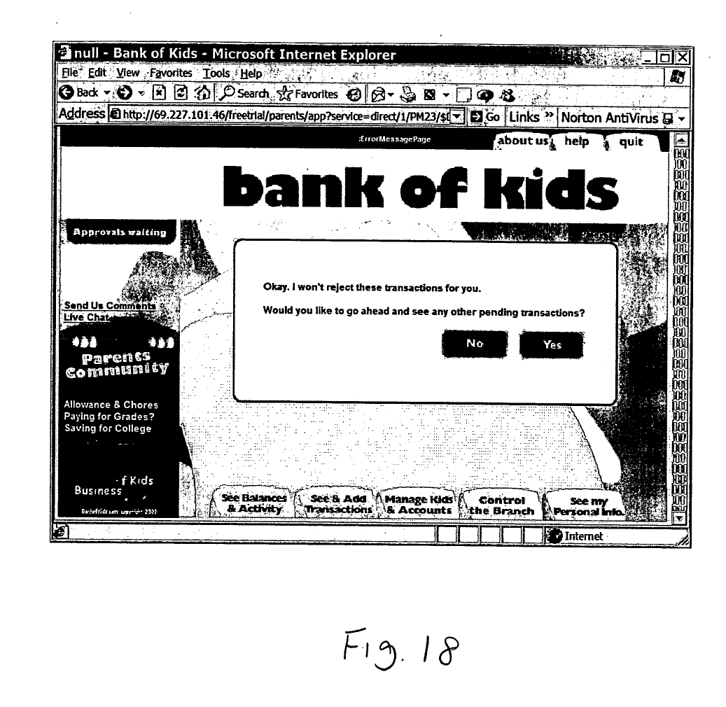

FIG. 18 then shows the result of canceling a rejection and the option to see other pending transactions. Other types of transactions are accomplished through similar screens.

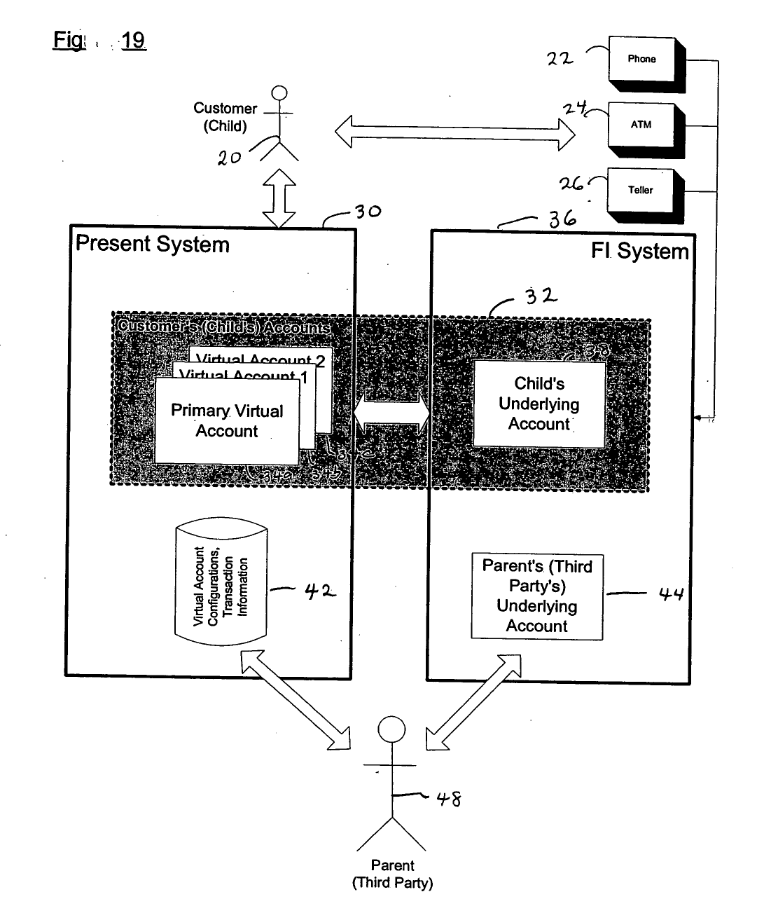

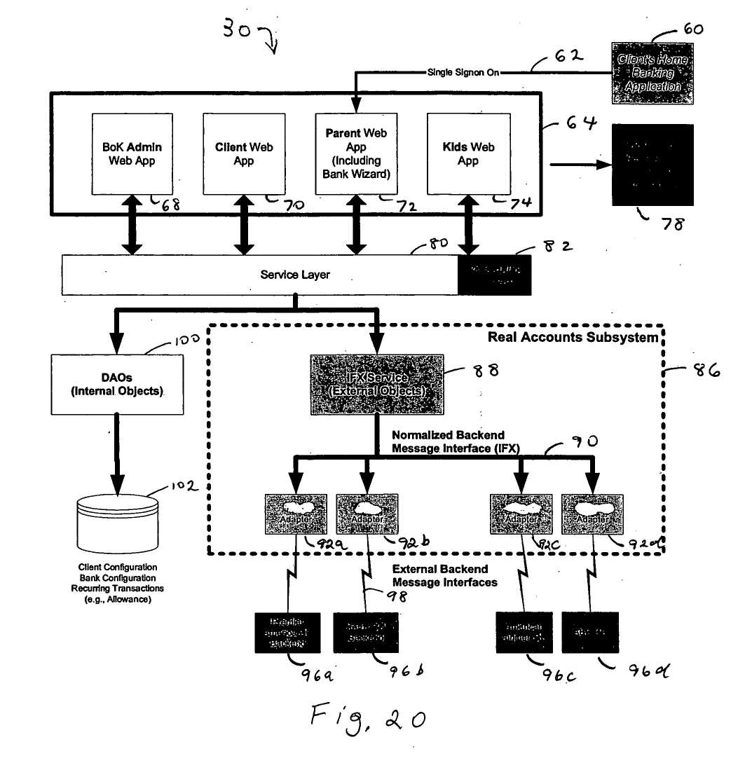

FIGS. 19-20 show how the present system delivers the virtual account to customers under management of the third party. FIG. 19, as described above, shows that the third party and customers each have access to the present system, for different purposes. In addition, the customer continues to have access through conventional access mechanisms to the financial institution such as by telephone, tellers, and ATMs. The customer (child) 20 may interact conventionally via telephone 22, ATM 24, or bank teller 26 with the financial institution IPS 36. Also, in accordance with this disclosure, the customer 20 may interact with the present system 30. The present system 30 includes as shown the child's accounts 32 which exist in the present system 30 as primary Virtual Account 34a, Virtual Account 1 34b and Virtual Account 2 34c. Of course, other virtual accounts may also be present. The child's accounts also exist in terms of the child's underlying account 38 at the financial institution as maintained in its IPS 36. Also maintained at the financial institution is the parent's third party underlying account 44 with which parent 48 may interact conventionally. The parent may also interact with the present system 3.0 via the Virtual Account configurations and transaction information 42.

FIG. 20 shows detail of the present system 30. FIG. 20 shows a number of software modules; the organization and functionality of same is a matter of implementation as are the designations of the various software modules here which are for purposes of description rather than limitation. In the present system 30, there is interaction with the financial institution (here called the “Client”) home banking application 60. Application 60 is the existing software which most banks/credit unions/stockbrokers, etc., offer for customers at home interacting via the Internet with the financial institution IPS 36 in FIG. 19. Hence application 60 is part of the environment rather than part of the present system 30. There is provided a “single sign on” access 62 which is conventional to the main part of the present system 64 which in this case has four modules.

The modules are the Bank of Kids administrative web application 68, the client (financial institution) web application 70, the parent web application 72, and the kids' web application 74. “Web application” is intended to convey that these are software modules (applications) intended for Internet communications and access. The administrative module 68 is internal to the present system 30 hence designated “BoK”. The client web application 70 is for use by the financial institution which holds the underlying accounts. The parent web application 72 is for use by the parent and includes what is called here a “banking wizard”, for instance the sign on and account set up procedures. The kid's web application 74 is for use by the child. Software 64 including the four modules interacts with a conventional software surface layer 80 which includes a messaging system 82. The parents and kids may interact with chat and on-line support system 78 maintained by the financial institution if they need help. System 78 is not necessarily part of the present system 30.

Service layer 80 is in communication with the real account subsystem 86 further detail of which is given below. Real accounts subsystem 86 includes an IFX (interactive financial exchange) service 88. (IFX is a software standard in the financial services field.) Service 88 provides various external objects with which system 30 interacts. IFX service 88 is connected by normalized backend message interface which is also part of the IFX standard to a set of adapter modules 92a, 92b, 92c and 92d. Typically there is one such adapter for each pertinent vendor of financial institution IPSS. Two such vendors are RDS and Summit. These are only exemplary.

It is expected that there only need be a single type of adapter 92 for each financial institution which is using the RDS software and a single adapter for each institution using the Summit software, etc. Hence in this case the adapters 92a, etc. are shown grouped by, for instance, vendor type. Hence each individual financial institution “backend” (which is part of IPS for the financial institution) 96a, 96b, 96c and 96d is connected by an external backend message interface 98 provided by the respective adapter 92a, etc. As shown in this case there are various financial institutions each with its own backend, such as the Premier America Credit Union, the Xerox Credit Union, the American Airlines Credit Union, and the ABC Credit Union. Also connected to service layer 80 are the data access objects 100 which in turn interact with the client (financial institution) configuration 102 for recurring transactions such as providing an allowance.

The following describes in further detail implementation of the present system 30 in terms of account set up and various transactions as shown above for particular transactions by means of the screen shots.

The real accounts subsystem 86 is a web computer program application which provides access to account information and transactional capabilities at financial institutions. Each financial institution has a different data processing system (EPS). The real accounts subsystem 86 provides the framework in which to deploy largely conventional software adapter components 96a, 96b, 96c, 96d of FIG. 20 that are unique to each financial institution's systems. For example, credit unions as shown in FIG. 20 typically use an IPS from a third party vendor to provide their data processing and account management's software.

The real accounts subsystem 86 allows the present system 30 to be independent of the specific data processing vendor and IPS used by financial institutions. The real accounts subsystem leverages the tools and software used for conventional business enterprise integration. Thus, an XML-based backbone is used in one version, as well as a well defined message set for normalization. The real accounts subsystem in one version supports and addresses real-time, request/response interfaces. Other version may support batch interfaces.

The following is a description of the detailed operation in a structured format from which the software is readily coded. The human participants are the child (called here a “kid”) or other customer, and parent or third party (who may be an administrative user). There is also the financial institution.

The following is organized into sections, each of a particular account set up or transaction, in terms of human and corresponding software activity. Each Section 1-7 is a data access object 100, see FIG. 20.

1. Enrolling a Kid

| | |
|---|---|
| Scenario: | Parent is already a user on the system and |
| | has logged in. Parent wants to enroll a |
| | new kid who has an existing account at |
| | the client financial institution. |
| Primary Business Actors | Parent User, BoK System, FI System |
| Pre-Condition | Parent navigates to BOK system, and |
| | signs on. |

Main Flow

| Parent | System |
|---|---|
| | Displays various things that a user can do |
| Selects ‘Add a Kid’ (may | |
| navigate through menus) | |
| | Retrieve list of accounts that parent has |
| | access to from client system. Present list. |
| Selects one of the accounts | |
| | Kid gets password set up for new access. |
| | Prompt parent for information about kid |
| | (some info will be display only since it is |
| | kept on Client System) |
| Enters BOK unique kid data | |
| (allowance, how spend | |
| money, etc.) | |
| | Sets up kid info in BoK DB (database). |
| | Prompt parent for setup info on kid's. |
| | primary virtual acct |
| Enter interest rate and WD | |
| constraints | |
| | Create kid account |
| Select ‘print summary page’ | |
| | Prints page showing summary of kid and |
| | kid's account |
| Post-Condition | |
| Backend Msgs: | None |

2. Kid Makes a Deposit

| | |
|---|---|
| Scenario: | Kid wants to deposit money. Kid does |
| | deposit request on system, presents |
| | deposit slip and money to parent or |
| | deposits in virtual “ATM”, parent logs |
| | onto system and “approves” deposit |
| Used by | |
| Primary Business Actors | Kid, System |
| Secondary Business Actor | Parent |
| Pre-Condition | Kid logs in |

Main Flow

| | | |
|---|---|---|
| Kid | BOK System | FI System |

| | | | |
|---|---|---|---|
| 1. | Selects ‘Deposit’ on | | |
| | Kids Home Page | | |
| | | 2. | Display List of |
| | | | Accounts and prompt |
| | | | for Deposit Amount |
| 3. | Select Account from | | |
| | list of Accounts. Enter | | |
| | Deposit Amount | | |
| | | 4. | Present verification |
| | | | screen, and ask if kid |
| | | | wants to complete |
| | | | the deposit. |
| 5. | Confirm they want to | | |
| | do deposit | | |
| | | 6. | EXECUTE KID |
| | | | DEPOSIT |
| | | | TRANSACTION - |

| | |
|---|---|
| a. | Create transaction |
| | record. |
| | Status = Pending |
| b. | DO NOT Update |
| | any balances |
| c. | DO NOT transact |
| | on real system |

| | | | |
|---|---|---|---|
| | | 7. | Present confirmation |
| | | | screen, noting that |
| | | | the deposit is |
| | | | pending. It will be |
| | | | completed and kid |
| | | | balances will |
| | | | increase when parent |
| | | | approves the |
| | | | transaction. |
| 8. | Kid selects to print | | |
| | Deposit Slip go to | | |
| | step 9. Kid selects not | | |
| | to print deposit slip go | | |
| | to step 10. | | |
| | | 9. | System prints deposit |
| | | | slip |
| | | 10. | Done |
| | | 11. | |
| | | 12. | Remind kid to give |
| | | | deposit to parent or |
| | | | put into virtual ATM |

| | |
|---|---|
| Post Condition | Verification transaction gets queued for |
| | parent |
| | Deposit transaction is flagged as |
| | “pending” |
| | Balances are NOT changed. No FI |
| | Transaction is executed. |
| Backend Msgs: | Deposit |

3. Parent “Approves” Kid's Deposit

| | |
|---|---|
| Scenario: | Kid has made a deposit on the system. |
| | The system has created the transaction. |
| | However, no balances have been updated, |
| | and no transaction has been issued to the |
| | FI. The transaction remains flagged as |
| | “Pending”. Parents will “Approve” this |
| | deposit after they have received the |
| | money from the kid. |
| Used by | |
| Primary Business Actors | Parent, BOK System, FI System |
| Secondary Business Actor | Kid |
| Pre-Condition | Deposit is pending for Parent to Approve |

Main Flow

| Parent | | BOK System | | FI System | |
|---|---|---|---|---|---|
| 1. | Selects | | | | |
| | “Review | | | | |
| | Pending | | | | |
| | Transactions” | | | | |
| | | 2. | Displays list of | | |
| | | | transactions pending | | |
| | | | for verification. | | |
| | | | Following details | | |
| | | | are displayed for | | |
| | | | each transaction: | | |
| | | | Kid Name | | |
| | | | Account Name | | |
| | | | Transaction Date | | |
| | | | Transaction Type | | |
| | | | (Deposit/ | | |
| | | | Withdrawal) | | |
| | | | Amount | | |
| 3. | Selects the | | | | |
| | deposit | | | | |
| | transaction | | | | |
| | to be approved. | | | | |
| | | 4. | Display verification | | |
| | | | screen with details of | | |
| | | | the transaction that | | |
| | | | will be approved. | | |
| | | | Notify parent that this | | |
| | | | will make an | | |
| | | | immediate transfer of | | |
| | | | $$ from their account | | |
| | | | at FI to their Kid's | | |
| | | | account at the FI. | | |
| | | | Ask for confirmation. | | |
| 5. | Select confirm | | | | |
| | | 6. | Issue Transfer Request | | |
| | | | to FI System moving | | |
| | | | deposit amount from | | |
| | | | Parent's FI Account to | | |
| | | | Kid's FI Account | | |
| | | | | 7. | Execute |
| | | | | | immediate |
| | | | | | transfer from |
| | | | | | Parent to |
| | | | | | Kid account. All |
| | | | | | balances |
| | | | | | immediately |
| | | | | | updated. |
| | | | | | Confirm back |
| | | | | | to BOK System. |
| | | 8. | Update BOK balances. | | |
| | | | Mark the transaction | | |
| | | | as “Approved”. | | |
| | | | Display confirmation | | |
| | | | message that kid | | |
| | | | deposit and transfer at | | |
| | | | FI completed. | | |

| | |
|---|---|
| Post Condition | Transactions are marked as Approved |
| Backend Msgs: | Transfer from Parent to Kid Account. |

4. Parent “Rejects” Kid's Deposit

| | |
|---|---|
| Scenario: | Kid has made a deposit on the system. |
| | The system has created the transaction. |
| | However, no balances have been |
| | updated, and no transaction has been |
| | issued to the FI. The transaction remains |
| | flagged as “Pending”. Parents can |
| | “Reject” this deposit if they determine |
| | that it is bogus. |
| Used by | |
| Primary Business Actors | Parent, BOK System |
| Secondary Business Actor | Kid |
| Pre-Condition | Deposit is pending for Parent |

Main Flow

| | |
|---|---|
| Parent | BOK System |

| | | | |
|---|---|---|---|
| 1. | Selects “Review | | |
| | Pending Transactions” | | |
| | | 2. | Displays list of transactions pending |
| | | | for verification. Following details are |
| | | | displayed for each transaction: |
| | | | Kid Name |
| | | | Account Name |
| | | | Transaction Date |
| | | | Transaction Type (Deposit/ |
| | | | Withdrawal) |
| | | | Amount |
| 3. | Selects the deposit | | |
| | transaction to be | | |
| | rejected. | | |
| | | 4. | Display verification screen with details |
| | | | of the transaction that will be rejected. |
| | | | Notify parent that this will not affect |
| | | | any balances of conduct any |
| | | | transaction at the FI. Ask for |
| | | | confirmation. |
| 5. | Select confirm | | |
| | | 6. | Mark the transaction as “Rejected”. |
| | | | Display confirmation message deposit |
| | | | was rejected. It will not be counted in |
| | | | the kid's balance. |

| | |
|---|---|
| Post Condition | Transactions are marked as rejected |
| Backend Msgs: | (none) |

5. Kid Makes a Withdrawal

| | |
|---|---|
| Scenario: | Kid decides to withdraw money. Kid |
| | does withdrawal on system, presents WD |
| | slip to parent or deposits in “ATM”, kid |
| | receives money, parent logs onto system |
| | and “Approves” withdrawal. |
| Used by | |
| Primary Business Actors | Kid, System |
| Secondary Business Actor | Parent |
| Pre-Condition | Kid logs in. |

Main Flow

| Kid | | BOK System | | | |
|---|---|---|---|---|---|
| 1. | Selects ‘Withdrawal’ | | | | |
| | on Kids Home Page | | | | |
| | | 2. | Display List of | | |
| | | | Accounts and | | |
| | | | prompt for | | |
| | | | Withdrawal Amount | | |
| 3. | Selects Account and | | | | |
| | enters Amount | | | | |
| | | 4. | Verify whether | | |
| | | | transaction is | | |
| | | | permitted - check | | |
| | | | following: | | |
| | | | Whether | | |
| | | | withdrawal is | | |
| | | | allowed on this | | |
| | | | account based on | | |
| | | | account type | | |
| | | | Whether | | |
| | | | withdrawal | | |
| | | | amount is less | | |
| | | | than or equal to | | |
| | | | one time | | |
| | | | withdrawal | | |
| | | | permitted based | | |
| | | | on account type | | |
| | | | If transaction is not | | |
| | | | permitted, display | | |
| | | | message and start | | |
| | | | over. | | |
| | | | If transaction is | | |
| | | | permitted, continue | | |
| | | 5. | Display verification | | |
| | | | screen with details | | |
| | | | of the withdrawal | | |
| | | | that will be | | |
| | | | completed. Notify | | |
| | | | kid that this will | | |
| | | | make an immediate | | |
| | | | transfer of $$ from | | |
| | | | their account at FI to | | |
| | | | their Parent's | | |
| | | | account at the FI. | | |
| | | | Ask for | | |
| | | | confirmation. | | |
| 6. | Kid confirms | | | | |
| | | 7. | Issue Transfer | | |
| | | | Request to FI | | |
| | | | System moving | | |
| | | | withdrawal amount | | |
| | | | from Kid's FI | | |
| | | | Account to Parent's | | |
| | | | FI Account | | |
| | | | | 8. | Execute immediate |
| | | | | | transfer from Kid to |
| | | | | | Parent account. All |
| | | | | | balances immediately |
| | | | | | updated. Confirm back to |
| | | | | | BOK System. |
| | | 9. | Create Withdrawal | | |
| | | | transaction. Update | | |
| | | | BOK balances. | | |
| | | | Mark the transaction | | |
| | | | as “Pending”. | | |
| | | | Display | | |
| | | | confirmation | | |
| | | | message that kid | | |
| | | | withdrawal and | | |
| | | | transfer at FI | | |
| | | | completed. | | |
| | | 10. | Prompt whether kid | | |
| | | | wants to print | | |
| | | | withdrawal slip. | | |
| 11. | Kid selects to print | | | | |
| | Withdrawal slip go to | | | | |
| | step 12. Kid selects | | | | |
| | not to print | | | | |
| | withdrawal slip go to | | | | |
| | step 7 | | | | |
| | | 12. | System prints | | |
| | | | withdrawal slip | | |
| | | 13. | Displays Account | | |
| | | | Balance screen with | | |
| | | | decreased Balance | | |
| | | 14. | Display message | | |
| | | | about what to do | | |
| | | | next for getting | | |
| | | | his/her money. | | |

| | |
|---|---|
| Post Condition | Verification transaction gets queued for |
| | parent |
| Backend Msgs | Withdraw |

Parent “Approves” Kid's Withdrawal

| | |
|---|---|
| Scenario: | Kid has made a Withdrawal on the |
| | system. The system has created the |
| | transaction. Balances have been updated, |
| | and a transfer transaction has been |
| | executed by the FI. Therefore, money |
| | has already been moved from the Kid's |
| | FI Account to the Parent's FI Account. |
| | The BoK transaction remains “Pending”. |
| | Parents can “Approve” or “Reject” this |
| | Withdrawal. This is the Approve case. |
| Used by | |
| Primary Business Actors | Parent, BOK System |
| Secondary Business Actor | Kid |
| Pre-Condition | Deposit is pending for Parent |

Main Flow

| Parent | | BOK System | |
|---|---|---|---|
| 1. | Selects “Review | | |
| | Pending | | |
| | Transactions” | | |
| | | 2. | Displays list of transactions pending |
| | | | for verification. |
| 3. | Selects the withdrawal | | |
| | transaction to | | |
| | be Approved. | | |
| | | 4. | Display a verification screen with |
| | | | details of the withdrawal that will be |
| | | | approved. Notify parent that this will |
| | | | not change any balances or conduct |
| | | | any transaction at the FI. Ask for |
| | | | confirmation. |
| 5. | Select confirm | | |
| | | 6. | Mark the withdrawal as “approved”. |
| | | | Display confirmation message |
| | | | withdrawal was approved. |

| | |
|---|---|
| Post Condition | Transactions are marked as rejected |
| Backend Msgs: | (none) |

7. Parent “Rejects” Kid's Withdrawal

| | |
|---|---|
| Scenario: | Kid has made a Withdrawal on the |
| | system. The system has created the |
| | transaction. Balances have been updated, |
| | and a transfer transaction has been |
| | executed by the FI. Therefore, money |
| | has already been moved from the Kid's |
| | FI Account to the Parent's FI Account. |
| | The BoK transaction remains “Pending”. |
| | Parents can “Approve” or “Reject” this |
| | Withdrawal. This is the Reject case. |
| Used by | |
| Primary Business Actors | Parent, BOK System, FI System |
| Secondary Business Actor | Kid |
| Pre-Condition | Deposit is pending for Parent to Approve |

Main Flow

| Parent | | BOK System | | FI System | |
|---|---|---|---|---|---|
| 1. | Selects “Review | | | | |
| | Pending Transactions” | | | | |
| | | 2. | Displays list of | | |
| | | | transactions pending | | |
| | | | for verification. | | |
| 3. | Selects the Withdrawal | | | | |
| | transaction to be | | | | |
| | withdrawal. | | | | |
| | | 4. | Display verification | | |
| | | | screen with details of | | |
| | | | the withdrawal. | | |
| | | | Notify parent that this | | |
| | | | will cause an | | |
| | | | immediate transfer of | | |
| | | | $$ from their account | | |
| | | | at FI back to their | | |
| | | | Kid's account at the | | |
| | | | FI. Ask for | | |
| | | | confirmation. | | |
| 5. | Select confirm | | | | |
| | | 6. | Issue Transfer | | |
| | | | Reversal Request | | |
| | | | (IFX) to FI System | | |
| | | | moving withdrawn | | |
| | | | amount from Parent's | | |
| | | | FI Account to Kid's | | |
| | | | FI Account. | | |
| | | | | 7. | Execute immediate |
| | | | | | transfer from Parent to |
| | | | | | Kid account. All |
| | | | | | balances immediately |
| | | | | | updated. Confirm back to |
| | | | | | BOK System. |
| | | 8. | Update BoK | | |
| | | | balances. Mark the | | |
| | | | transaction as | | |
| | | | “Rejected”. Display | | |
| | | | confirmation message | | |
| | | | that kid Withdrawal | | |
| | | | has been rejected | | |
| | | | (cancelled) and | | |
| | | | money has been | | |
| | | | moved back to kid's | | |
| | | | account at FI. | | |

| | |
|---|---|
| Post Condition | Transactions are marked as Approved |
| Backend Msgs: | Transfer from Parent to Kid Account. |

The above is illustrative; other transactions are readily understood and implemented using similar processes.

The present system has features which assist parents and kids in complying with account withdrawal restrictions (which are imposed by regulators). For example, a savings account often has a limited number of withdrawals permitted each month, as defined by Regulation D. This applies to the underlying real account at the financial institutions and not to the individual virtual accounts implemented by the present system. For example, a transfer of money from a kid's account to a parent's account for a kid's withdrawal, will likely count as a Regulation D withdrawal. However, movement of money between Virtual Accounts will not, since so actual funds are moved at the financial institution. Therefore, if the parent sets up a savings account to fund the deposits and payments to kids' accounts, the number of transactions such as paying interest or allowance each month, could be restricted by regulations. The follow are examples of ways the present system provides assistance for staying within the restrictions of the account terms and conditions, while continuing to offer the convenience and benefits for parents and kids:
1) The present system provides parents and kids with an updated count of the number of withdrawals made against the underlying account each time period (typically a month).
2) The present system allows certain transactions, which may be subject to restrictions, to be “batch” and executed in bulk. For example, suppose a child has three virtual accounts, each with a premium interest finded by their parent, to be paid monthly. Further suppose that one of the accounts has a “matching funds” provision, also funded by the parent, and that in a particular month, the child makes 2 deposits. Thirdly, suppose that the child is given an allowance of $5.00 per week. For a given month, this will typically result in nine transfers from the parent's to the kid's account, which may violate restrictions on the parent's account.

The present system assists parents by allowing them to setup these individual features of the account, and then “batching” the payments together. For example, the present system allows parents, by default, to pay interest to all virtual accounts on the same day, resulting in one real transaction between the parent and kid's real account for the total interest on all three virtual accounts, but having individual transactions on the present system for each of the virtual accounts. Further, the present system allows parents to meet their matching finds commitment by making a one contribution during the month to the kids account (typically at the end of the month), for the total of deposits that month. Similarly, the present system allows allowance to be batched and paid monthly.

In the example above, for both the matching finds and allowance transaction, the present system allows the parent to setup these transaction to provide credit to the kid's account (increases the kid's virtual account balance) on the day the payment is agreed to be made (for example, weekly on Friday for allowance, and at the time of deposit for the matching funds), so that interest will be accrued from that day forward. However, the funds will not be “available” until the actual transfer is made from the parent accounts. Such distinction between “account balance” and “available balance” is part of the present system.

The present system allows kids to manage multiple (all) their real accounts at the financial institution, in the same fashion as present on-line banking systems. Further, it allows kids to make transactions directly between any of their real accounts and any of their virtual accounts. So if a kid has a real credit card with the financial institution, and wants to make a payment to that credit card, via the present system they can do that from any of their virtual accounts (subject to restrictions parents might impose on their virtual account). Additionally, the present system lets a kid move money from, say a real investment account at the financial institutions, to a virtual account setup for their car savings (which is not necessarily their primary virtual account.

This disclosure is illustrative but not limiting; further modifications will be apparent to those skilled in the art and are intended to fall within the scope of the present claims.

What is claimed as new and desired to be protected by Letters Patent of the United States is:

1. A method of financial management, wherein a customer has an account at a financial institution and a third party has an account at the financial institution, the method comprising the acts of:
establishing a relationship between the third party account and the customer account;
performing a plurality of transactions between the third party account and the customer account at instigation of either of the customer or third party; and
reporting the plurality of transactions to the customer, whereby the reporting to the customer is of a transaction differing from the actual transaction.

2. The method of claim 1, wherein the third party is a relative, guardian, or friend of the customer.

3. The method of claim 1, wherein the third party is a business entity.

4. The method of claim 1, wherein the transaction is a deposit to or withdrawal from the customer account.

5. The method of claim 4, wherein the transaction is a deposit to the customer account that is reported as an interest payment, allowance payment or other such specialized payments.

6. The method of claim 1, wherein the reporting is such that characteristics of the customer account are reported to the customer as being different from characteristics of the customer account as set by the financial institution.

7. The method of claim 1, wherein the method is carried out by an entity other than the financial institution.

8. The method of claim 1, wherein the method is carried out by the financial institution.

9. The method of claim 1 there being a loan between the customer and third party, and further comprising the act of repaying the loan as a transaction.

10. The method of claim 6, wherein at least one of the reported characteristics of the customer account is not known to the financial institution.

11. The method of claim 1, further comprising the act of establishing a virtual account associated with the customer account, wherein the additional virtual account is maintained by an entity other than the financial institution.

12. The method of claim 11, wherein the virtual account has characteristics other than those offered by the financial institution on the customer or third party account, and are specified by the third party.

13. The method of claim 11, further comprising the act of establishing at least a second virtual account associated with the customer account.

14. The method of claim 11, wherein a total funds balance in all virtual accounts associated with one customer account equals the funds balance in the customer account.

15. The method of claim 1, wherein the method is carried out without any required modification to an information processing system at the financial institution.

16. The method of claim 6, wherein the third party determines the characteristics as reported to the customer.

17. The method of claim 14, wherein a plurality of virtual accounts are established.

18. The method of claim 15, wherein the total funds balance is reconciled against the funds balance upon occurrence of a predetermined condition.

19. The method of claim 1, wherein the customer and third party access their respective accounts through at least one of an automated teller machine, bank branch, and on-line banking, and reconciling of their respective accounts occurs.

20. A set of software instructions stored on a computer readable medium and suitable to be executed on a computer to carry out the method of claim 1.

21. The set of software instructions of claim 21, suitable to be carried out by one of a personal computer as an application program or by a server.

22. A financial management system, where a customer has an account at a financial institution and a third party has an account at the financial institution, the system comprising:
a third party module that accesses the third party account;
a customer module that accesses the customer account;
a financial institution module for access by the financial institution; and
an accounts subsystem that operatively connects the third party module and customer module thereby permitting transactions between the third party account and the customer account, whereby reports of the transactions to the customer may be of a transaction differing from the actual transaction.

23. The system of claim 22, wherein the third party is a relative, guardian, or friend of the customer.

24. The system of claim 22, wherein the third party is a business entity.

25. The system of claim 22, wherein the transaction is a deposit to or withdrawal from the customer account.

26. The system of claim 25, wherein the transaction is a deposit to the customer account that is reported as an interest payment, allowance payment or other such specialized payments.

27. The system of claim 22, wherein the reporting is such that characteristics of the customer account are reported to the customer as being different from characteristics of the customer account as set by the financial institution.

28. The system of claim 22, wherein the system is operated by an entity other than the financial institution.

29. The system of claim 22, wherein the system is operated by the financial institution.

30. The system of claim 22, there being a loan between the customer and third party, and further comprising means for repaying the loan as a transaction.

31. The system of claim 27, wherein at least one of the reported characteristics of the customer account is not known to the financial institution.

32. The system of claim 22, further comprising means for establishing a virtual account associated with the customer account, wherein the virtual account is maintained by an entity other than the financial institution.

33. The system of claim 32, wherein the virtual account has characteristics other than those offered by the financial institution on the customer or third party account and are specified by the third party.

34. The system of claim 32, further comprising means for establishing at least a second virtual account associated with the customer account.

35. The system of claim 34, wherein a total funds balance in all virtual accounts associated with one customer account equals the funds balance in the customer account.

36. The system of claim 22, wherein the system operates without any required modification to an information processing system at the financial institution.

37. The system of claim 27, wherein the third party determines the characteristics as reported to the customer.

38. The system of claim 34, wherein there are a plurality of virtual accounts established.

39. The system of claim 35, wherein the total finds balance is reconciled against the funds balance upon occurrence of a predetermined condition.

40. The system of claim 22, wherein the customer and third party access their respective accounts through at least one of an automated teller machine, bank branch, and on-line banking, and reconciling of their respective accounts occurs.
